(19) United States
(12) Patent Application Publication
(10) Pub. No.: US 2020/0023474 A1
(43) Pub. Date: Jan. 23, 2020

(54) REMOTE PANELS FOR POWER SYSTEMS

(71) Applicant: Illinois Tool Works Inc., Glenview, IL (US)

(72) Inventor: Jonathon James Nelson, Menasha, WI (US)

(21) Appl. No.: 16/513,273

(22) Filed: Jul. 16, 2019

Related U.S. Application Data
(60) Provisional application No. 62/699,421, filed on Jul. 17, 2018.

(51) Int. Cl. B23K 37/02; B23K 9/10

(52) U.S. Cl. CPC B23K 37/0294; H02J 7/0052; B23K 37/0282; B23K 9/1006

(57) ABSTRACT

A plurality of modular panels for a vehicle mounted welding-type power system are disclosed. A control panel transmits information to and receive information from a control device of the welding-type power system. A first power output panel is configured to provide power to a welding-type tool, and a second power output panel is configured to provide power output to an auxiliary device. Each of the control panel, the first power output panel and the second power output panel are in electrical communication with the welding-type power system, the control device configured to control power output to the first and second power output panels based on information from the control panel. Further, each of the control panel, the first power output panel and the second power output panel are configured to be positioned at locations that are separate and remote from one another.

### CROSS REFERENCE TO RELATED APPLICATIONS

This application claims priority to U.S. Provisional Patent Application Ser. No. 62/699,421, filed Jul. 17, 2018, entitled “Remote Panels for Power Systems”. The entirety of U.S. Provisional Patent Application Ser. No. 62/699,421 is incorporated herein by reference.

### BACKGROUND

The present disclosure relates generally to power systems and, more particularly, to remotely located panels for power systems, including vehicle mounted power systems.

Conventional power systems for work vehicles provide auxiliary service, particularly electrical power, compressed air service and hydraulic service. Conventional power systems may include a remote user interface such as a sheet metal-constructed panel or box that contains controls and/or connections for welding operations and/or provision of electrical power, for example. In conventional control panels, a single, large box contains all the user controls and outlets, which must be positioned at a single point, for example, at a location mounted to the work truck. Requiring all controls and outlets to be co-located creates issues with cabling to and from the panel, as well as making access to controls less accessible during a field operation.

Thus, a need exists for a paneling solution that provides operators greater flexibility in controlling and operating tools from a work vehicle.

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

Disclosed are examples of modular panels for a vehicle mounted welding-type power system. In particular, the modular panels may include a control panel configured to transmit information to and receive information from a control device of the welding-type power system and one or more power output panels configured to provide power for a welding-type tool, a battery charger, an auxiliary device, among others.

More particularly, each of the panels is modular, such that each can be separately mounted at unique locations about the vehicle (e.g. a service vehicle) and/or in the work environment. In some examples, each of the control panel and power output panels are in electrical communication with the welding-type power system, the control device being configured to control power output to the first and second power output panels based on information from the control panel.

In conventional systems, a remote user interface may be a single sheet metal box that contains power outlets, control connections, and/or other components. In many examples, the front of the box has user controls, with attachment points at the back of the box to mount the box to a structure (e.g., a vehicle). This type of construction can make installation of the remote panel difficult, as the box is large, heavy and therefore difficult to install. Further, all controls and outlets are in a single location. The conventional system is therefore difficult to customize, preventing an operator to arrange power and control outputs in an optimal arrangement.

The disclosed modular remote panels improves on the conventional systems by allowing an operator to split the panels associated with one or more of a DC power output, an AC power output, a weld power output, a battery charging outoput, as well as control connections and components, into separate panels which may be located remote from one another. For example, the panels may be formed of aluminum, sheet metal, polymers, among others. This allows each panel to be smaller and lighter, which makes each panel easier to handle and to mount. Separating the power, weld, battery charge, and control connections and components into separate remote panels reduce size and weight allowing users to put the remotes at a desired point of use.

The disclosed modular panels also improves on conventional designs by allowing users to mount each panel in different locations. This is beneficial to an operator as they can mount their power, weld, battery charge, and control connections and components remotes at a point of use near associated equipment, tools, workspace, etc. Typically, service trucks have dedicated cabinets configured to house specific tools. Separating the remote panels allows the service truck operator to match the remote panel to a specific cabinet with similar tools. Another benefit associated with separately mounting remote panels is the simplification of routing cables to each panel. Thus, the separately routed cables are directed to each individual remote from the main power unit or source.

In disclosed examples, a plurality of modular panels for a vehicle mounted welding-type power system include a control panel to transmit information to and receive information from a control device of the welding-type power system. A first power output panel configured to provide power to a welding-type tool or a battery charger. A second power output panel configured to provide power output to an auxiliary device, wherein each of the control panel, the first power output panel and the second power output panel are in electrical communication with the welding-type power system, the control device configured to control power output to the first and second power output panels based on information from the control panel.

In some examples, each of the control panel, the first power output panel and the second power output panel are configured to be positioned at locations on the vehicle that are separate and remote from one another. In examples, the first power output panel is connected to the power system via a first power cable. In some examples, the second power output panel is connected to the power system via a second power cable. In examples, the first power output cable comprises a plurality of conductors of a first conductor gauge that is greater than a second conductor gauge of a plurality of conductors of the second power output cable.

In some examples, the control panel is connected to the power system via one or more conductors with a third conductor gauge that is smaller than the conductor gauge of the second power output cable. In examples, a mount is included to secure one or more of the control panel, the first power output panel or the second power output panel to the vehicle. In some examples, the control panel is configured as a hub, such that the first cable and the second cable are channeled through the control panel to each of the first and second power output panels for placement remote from the control panel.

In some examples, one or more of the control panel, the first power output panel, and the second power output panel is housed in a frame comprising aluminum, sheet metal or rigid plastic.

In some disclosed examples, a power system for a vehicle includes a generator to generate electrical power and to be installed on the vehicle. A control device is configured to receive information for controlling electrical power output of the generator. A first power output panel is located at a first location on the vehicle and configured to provide electrical power from the generator to a welding-type tool or a battery charger. A second power output panel is located at a second location on the vehicle and configured to provide electrical power from the generator to an auxiliary device. And a control panel located at a third location on the vehicle and configured to receive information from and transmit information to the control device of the power system via a control cable.

In some examples, the electrical power output comprises at least one of a 120V alternating current output, a 240V alternating current output, a 24V direct current output, or a 12V direct current output. In examples, the control panel comprises a selection switch to control an output voltage of the electrical output. In some examples, the first power output panel comprises a welding output connector to provide the electrical power output to the welding-type tool.

In some examples, electrical conversion circuitry is included to receive the electrical power from the generator and to provide converted electrical power to the electrical output based on a selection. In some examples, the second power output panel comprises an output receptacle to provide the electrical power output as 120V or 240V alternating current output. In some examples, one of the first and second power output panel comprises an indicator to alert the operator to a characteristic of an output associated with the respective panel.

In some examples, the control panel is further configured to control one or more components associated with the vehicle or the power system, the one or more components including the generator, a hydraulic pump or an air compressor.

In some disclosed examples, a vehicle mounted welding-type power system includes a generator to generate electrical power and to be installed on the vehicle. A control device receives information for controlling electrical power output of the generator. A first power output panel is located at a first location on the vehicle and configured to provide welding-type electrical power from the generator to a welding-type tool or a battery charger. A second power output panel is located at a second location on the vehicle and configured to provide electrical power from the generator to an auxiliary device. And a control panel is located at a third location on the vehicle. The control panel is configured to receive an input from a user to provide electrical power to the first power output panel or the second power output panel, and to transmit the input to the control device of the power system to control the electrical power output.

In some examples, the control panel includes a first control panel to control the first power output, and a second control panel separate and remote from the first control panel, the second control panel configured to control the second power output. In examples, the control panel transmits information to and receive information from the power system wirelessly to control the first and second power outputs.

### DRAWINGS

These and other features, aspects, and advantages of the present disclosure will become better understood when the following detailed description is read with reference to the accompanying drawings in which like characters represent like parts throughout the drawings, wherein:

FIG. 1 is a diagrammatical overview of a work vehicle in which a plurality of modular remote panels are in communication with a service pack, in accordance with aspects of this disclosure.

FIG. 2 illustrates a front view of an example remote control panel, in accordance with aspects of this disclosure.

FIG. 3 illustrates a front view of an example power output panel, in accordance with aspects of this disclosure.

FIG. 4 illustrates a front view of another example power output panel, in accordance with aspects of this disclosure.

FIG. 5 illustrates an example conventional cabling set up for a power system and a conventional remote device.

The figures are not necessarily to scale. Where appropriate, similar or identical reference numbers are used to refer to similar or identical components.

### DETAILED DESCRIPTION

One or more embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions are made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Disclosed examples of the modular remote panels improve upon the conventional, integrated remote control panels for power systems by making each remote panel independent, each of which can be mounted in separate locations on the work vehicle and/or near the work site. The modularized panels may contain controls and/or outputs that may serve a common purpose, such as providing 120V and 240V AC outputs in a single panel. As a result, disclosed examples eliminate the separation of connections and allow for less complex wiring to each panel, such that only wiring that serves the particular output and/or control is run to the particular panel.

A wide range of work vehicles have been developed and are presently in service. Present estimates are that hundreds of thousands of such vehicles are operating in the United States alone. Depending upon intended use, work vehicles may include integrated systems for performing operations such as welding, cutting, assembly, for example. Moreover, systems for such work vehicles have been developed for providing hydraulic and/or compressed air service to applications, such as for driving air tools, pneumatic lifts and other compressed air-driven devices, as well as hydraulic lifts, hydraulic tools, concrete and metal working tools, etc. Similarly, where electrical power is generated on a vehicle, such as by an electric generator driven by a gas or diesel motor, the electrical power may be made available for powering a welding-type tool, as well as electrical tools, lights, and a wide range of auxiliary devices.

Conventional power systems have dedicated, typically short wire leads with connectors or bulkhead connectors on the remote control box for an installer to make the electrical connections, including welding connections, auxiliary power connections, and/or battery charge connections. An integrated remote control box also contains the engine, component, and operational control switches and displays. Further, the construction of conventional, integrated remote control panels can make installation of such remote control panels challenging on a vertical panel due to the weight and dimensions of the box.

Disclosed examples improves upon the conventional, integrated remote control panels for power systems by making modular remote panels, which can be mounted in separate locations on the work vehicle and/or near the work site. The modularized panels may contain controls and/or outputs that may serve a common purpose, such as providing 120V and 240V AC outputs in a single panel. As a result, disclosed examples allow for less complex wiring to each panel, such that only wiring that serves the particular output and/or control is run to the particular panel.

The independence of each modular panel substantially reduces the difficulty of installation of each remote control panel compared to conventional, integrated remote control panels. For example, disclosed modular remote control panels enable a relatively simple, lightweight panel to be attached to a surface at the mounting location (e.g., the work vehicle), and limits the number and complexity of wiring to each panel.

Disclosed example panels also eliminate or reduce electrical connections made by an installer of the power system and/or remote control panel at or near the remote panel box, relative to conventional, integrated remote control panels. Disclosed examples use continuous wire leads from the power system to each modular remote panel. The elimination or reduction of electrical connections by an installer simplifies and/or improves the reliability of the electrical connections (e.g., makes the connections less susceptible to corrosion, improper installation, and/or poor installation techniques).

Mounting or attaching of the panel may require drilling holes in a cabinet or other surface and installing through-type fasteners (which can be difficult if the object being mounted, such as a conventional, integrated remote control panel, is large, heavy, or obstructed with multiple wires and/or leads). Because disclosed examples attach only those cables required for the particular remote panel, disclosed example remote control panels reduce or eliminate multiple points of the cabling between the remote and the power system and, as a result, reduces unnecessary strain on the cables, leads, electrical terminations, and/or electrical components.

For example, electrical connections and connectors are potential points of failure that can be hazardous. By reducing or eliminating electrical connections made at the remote control panel during installation, disclosed examples improve durability and/or reliability of the remote control panel and improves the quality of an installation.

In some examples, other communication techniques are used to further reduce the number of physical connections between the remote control panel and the power source. For example, each of the modular remote control panels may communicate with and/or control the power source using wireless communications such as WiFi, Bluetooth, 3GPP communications, Long Term Evolution (LTE), Zigbee, or any other communications methods. The example power source and/or modular remote control panels may additionally or alternative use weld cable communications to enable control of the power source over a weld cable from a remotely located wire feeder.

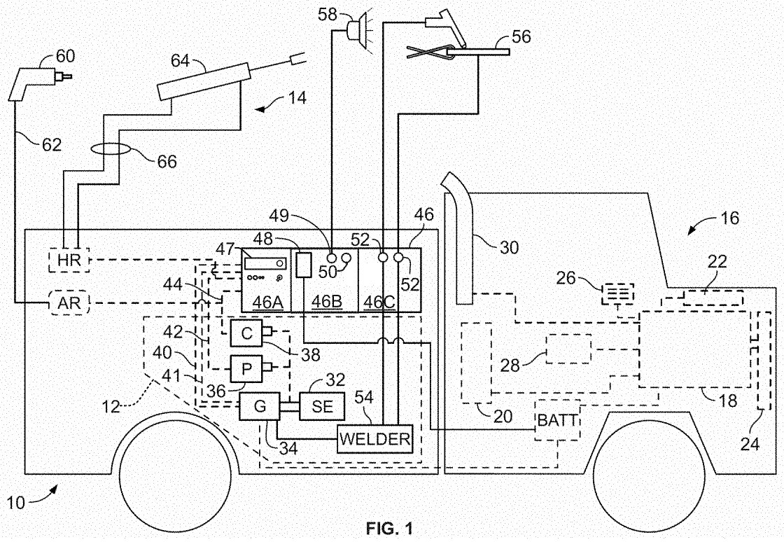

Turning now to the drawings, and referring first to FIG. 1, a work vehicle is illustrated including equipment in accordance with the invention. The work vehicle, designated generally by reference numeral 10, is shown as a work or service truck, although any suitable configuration for the vehicle may be envisaged. In the illustrated embodiment, the vehicle includes a power system, designated generally by reference numeral 12, for supplying electrical power, compressed air and hydraulic power to a range of applications, designated generally by reference numeral 14. The vehicle 10 has a main vehicle power plant 16 based around a vehicle engine 18. Although the invention is not limited to any particular configuration or equipment, work vehicle engines of this type will typically be diesel engines, although gasoline engines may be used in some vehicles. Moreover, although several examples are provided with reference to welding tools, equipment and processes, the power system 12 disclosed herein is equally applicable to various applications where power systems are utilized. In particular, the modular remote panels disclosed herein provide many benefits in work environments where customizing placement and/or function of control and/or power output would benefit the workflow (e.g., emergency situations, mobile work sites, military operations, temporary venues, etc.).

The vehicle power plant 16 includes a number of conventional support systems. For example, the engine 18 will consume fuel from a fuel reservoir 20, typically one or more liquid fuel tanks. An air intake or air cleaning system 22 supplies air to engine 18, which may be turbo charged or super charged in some applications. A cooling system 24, which will typically include a radiator, circulation pump, a thermostat-controlled valve and a fan, provides for cooling the engine. An electrical system, designated diagrammatically at the symbol 26 will include an alternator or generator, along with one or more system batteries, cabling for these systems, cable assemblies routing power to a fuse box or other distribution system, and so forth. A lube oil system 28 will typically be included for many engine types, such as for diesel engines. As will be appreciated by those skilled in the art, such lube oil systems typically draw oil from the diesel engine crankcase, and circulate the oil through a filter and cooler, if present, to maintain the oil in good working condition. Further, the power plant 16 will be served by an exhaust system 30, which may include catalytic converters, mufflers, and associated conduits.

The power system 12 may include one or more service systems driven by a service engine 32. In an example, the service pack provides electrical power, hydraulic power and compressed air for the applications 14. In the diagrammatical representation of FIG. 1, for example, the service engine drives a generator 34 as well as a hydraulic pump 36 and air compressor 38. The engine itself may be of any desired type, but in a this example a diesel engine is contemplated. Certain embodiments may use gasoline or other engines. The generator 34 may be directly driven by the engine, such as by close coupling the generator to the engine, or may be belt or chain driven, where desired. Presently contemplated generators include three-phase brushless types, capable of producing power for a range of applications. However, other generators may be employed, including single-phase generators and generators capable of producing multiple power outputs. The hydraulic pump 36 may be based on any conventional technology, such as piston pumps, gear pumps, vane pumps, with or without closed-loop control of pressure and/or flow. The air compressor 38 may also be of any suitable type, such as a rotary screw compressor, a reciprocating compressor based upon one or more reciprocating pistons, and/or any other type of compressor.

The systems of the power system 12 will include appropriate conduits, wiring, tubing and so forth for conveying the service generated by these components to an access point. Convenient access points will be located around the periphery of the vehicle. In some examples, all of the services may be routed to a common access point, although multiple access points can be provided. The diagrammatical view of FIG. 1 illustrates the generator 34 as being coupled to electrical cabling 40 (for AC power supply) and 41 (for 12 volt DC power supply), whereas the hydraulic pump 36 is coupled to hydraulic circuit 42, air compressor 38 is coupled to an air circuit 44. The wiring and circuitry for the three systems may include protective circuits for the electrical power, including fuses, circuit breakers, and so forth, as well as valves for the hydraulic and air service. For the supply of electrical power, certain types of power may be conditioned (e.g., smoothed, filtered, etc.), and DC power output may be provided by rectification, filtering and regulating of AC output. Example DC power outputs include 12V DC and 24V DC, but any other fixed and/or user-adjustable DC power outputs may be provided. Valves for hydraulic power output may include by way example, pressure relief valves, check valves, shut-off valves, as well as directional control valves. The hydraulic pump may draw fluid from and return fluid to a fluid reservoir, which will typically include an appropriate vent for the exchange of air during use with the interior volume of the reservoir, as well as a strainer or filter for the hydraulic fluid. Similarly, the air compressor 38 will typically draw air from the environment through an air filter.

As represented generally in FIG. 1, the generator 34 is also coupled to the vehicle electrical system, and particularly to the vehicle battery. Thus, the vehicle battery may serve as a shared battery with the power system 12, and a serviceable charge level is maintained by the output of the service pack generator.

The cabling 40 and the conduits 41, 42, and 44 may, as illustrated in FIG. 1, route service for all of these systems directly from connections on the service pack. In a presently contemplated embodiment, for example, connections are provided at or near a base of an enclosure of the service pack, such that connections can be easily made without the need to open the enclosure.

Moreover, certain control functions may be available from a modular remote panel 46. The modular remote panel 46, as noted above, may include a remote control panel 46A and one or more power output panels 46B, 46C. The modular remote panels 46A-46C may be located on any surface of the vehicle, on multiple locations in the vehicle, and/or on a structure in the work area, and may be covered by doors or other protective structures, where desired. The panels 46A-46C of the modular remote panels 46 may be located at locations of access to one or more components, such as with ready access to tools, equipment and/or output points of the service pack.

In some examples, each remote panel of the modular remote panels 46 is mounted at a different location separate and remote from any other. For instance, access to welding type tools may be at the rear of the vehicle; thus, a remote panel 46C with welding outputs may be mounted near those tools. A remote control panel 46A with one or more controls 47 may be located with other control function, such as near the vehicle operator's door.

In this example, the cabling for each of the modular remote panels 46A-46C will be routed directly to the respective panel. Thus, the heavy gauge wiring needed to support a welding operation need not be routed to or through the remote control panel 46A, as is required in conventional systems. Similarly, lower gauge, lower voltage, and in some cases more fragile, control wiring is run to the dedicated remote control panel 46A, and can be routed away from moving parts or otherwise encased in conduit to protect from damage and/or interference from other cabling.

The remote control panel 46A may permit, for example, starting and stopping of the service engine 32 by a keyed ignition or starter button. Other controls for the engine may also be provided on the remote control panel 46A. The remote control panel 46A may also provide operator interfaces 47 for controlling and/or monitoring the service engine 32, such as fuel level gauges, pressure gages, as well as lights and/or indicators for parameters such as pressure, speed, and so forth. The remote control panel 46A may also include a stop, disconnect or disable switch (not separately shown) that allows the operator to prevent starting of the service pack engine, such as during transport.

In the illustrated embodiment, for example, the remote control panel 46B includes one or more alternating current electrical outputs, which may take the form of electrical receptacles 48, 49 and 50 (for provision of 12 volt DC power and/or AC power), are provided. The remote control panel 46C includes welding connections, such as positive and negative terminals 52 to which a welding torch and/or a work cable may be connected to form a weld circuit.

In the embodiment illustrated in FIG. 1, the applications 14 may be coupled to the power system 12 by interfacing with appropriate outputs provided by the power system 12, either directly or via one or more of the modular remote power output panels 46B-46C. For example, the power system 12 includes a welder 54 (e.g., weld circuitry configured to convert power from the generator 34 to welding-type power) that provides current-controlled and/or voltage-controlled power suitable for a welding application. As will be appreciated by those skilled in the art, the welder 54 receives power from the electrical output of the generator 34, and contains circuitry configured to provide for appropriate regulation of the output power provided to cables suitable for a welding application 56, which connect to the welder 54 via welding connectors 52 on the remote power output panels 46B-46C. The presently contemplated embodiments include welders, plasma cutters, and so forth, which may operate in accordance with any one of many conventional welding techniques, such as stick welding, tungsten inert gas (TIG) welding, metal inert gas (MIG) welding, and so forth. Although not illustrated in FIG. 1, certain of these welding techniques may call for or, conveniently, use wire feeders to supply a continuously fed wire electrode, as well as shielding gasses and other shielding supplies. Such wire feeders may be coupled to the service pack and powered by the service pack and/or controlled by the remote control panel 46A, where desired.

Similarly, output loads, such as DC loads or AC loads, may be coupled to the receptacle 49. Such loads may include lights 58, or any other loads that would be powered by the power supply 12 and/or operation of the main vehicle engine 18. The example receptacle 48 at the remote power output panel 46B may, in some examples, be connected to the truck battery (or other portion of the truck electrical system) to provide battery charging and/or jump-starting the truck 10. The example receptacle 48 may be connected to the battery via a path that is internal to the body of the truck 10 and/or via an external path (e.g., an extension cable connected to a jump-start connector on the remote power output panel 46B). As mentioned above, the output of the service pack may also serve to maintain the vehicle battery charge, and to power any ancillary loads that the operator may need during work (e.g., cab lights, hydraulic system controls, etc.). Additionally or alternatively, a DC output may be used to provide DC power for loads other than those on the vehicle. For example, the DC output may be used to provide DC power for other vehicles (e.g., jump-starting, battery charging, auxiliary vehicle loads) and/or non-vehicle devices (e.g., electronic devices, chargers, etc.).

The pneumatic and hydraulic applications may similarly be coupled to the service pack 12 as illustrated diagrammatically in FIG. 1. For example, a hose 62 or other conduit may be routed from the compressed air source to a tool, such as an impact wrench 60. Many such pneumatic loads may be envisaged. Similarly, a hydraulic load, illustrated in the form of a reciprocating hydraulic cylinder 64 may be coupled to the hydraulic service by means of appropriate hoses or conduits 66. As noted above, and as will be appreciated by those skilled in the art, certain of these applications, particularly the hydraulic applications, may call for the use of additional valves, particularly for directional control and load holding. Such valves may be incorporated into the work vehicle and/or may be provided separately either in the application itself or intermediately between the service pack and the hydraulic actuators.

One or more of the applications illustrated diagrammatically in FIG. 1 may be incorporated into the work vehicle itself. For example, the work vehicle may be designed to include a man lift, scissor lift, hydraulic tailgate, or any other driven systems, which can be coupled to the service pack and driven separately from the main vehicle engine.

The power system 12 may be physically positioned at any suitable location in or on the vehicle. In an example, the service engine 32 may be mounted on, beneath or beside the vehicle bed or work platform rear of the vehicle cab. In many such vehicles, for example, the vehicle chassis may provide convenient mechanical support for the engine and certain of the other components of the service pack. For example, steel tubing, rails or other support structures extending between front and rear axles of the vehicle may serve as a support for the service engine 32. Depending upon the system components selected and the placement of the service pack, reservoirs may be provided for storing hydraulic fluid and pressurized air (denoted HR and AR, respectively in FIG. 1). The hydraulic reservoir may be placed at various locations or even integrated into the service pack enclosure. Likewise, depending upon the air compressor selected, no reservoir may be required for compressed air.

In use, the service pack provides power for the on-site applications completely separately from the vehicle engine. That is, the service engine 32 generally may not be powered during transit of the vehicle from one service location to another, or from a service garage or facility to a service site. Once located at the service site, the vehicle may be parked at a convenient location, and the main engine 18 may be shut down. The service engine 32 may then be powered, to provide service from one or more of the service systems described above. Where desired, clutches, or other mechanical engagement devices may be provided for engagement and disengagement of one or more of the generator, the hydraulic pump and the air compressor, depending upon these service are required. Moreover, as in conventional vehicles, where stabilization of the vehicle or any of the systems is require, the vehicle may include outriggers, stabilizers (not shown), and so forth which may be deployed after parking the vehicle and prior to operation of the service pack. The invention thus allows for a service to be provided in several different manners and by several different systems without the need to operate the main vehicle engine at a service site.

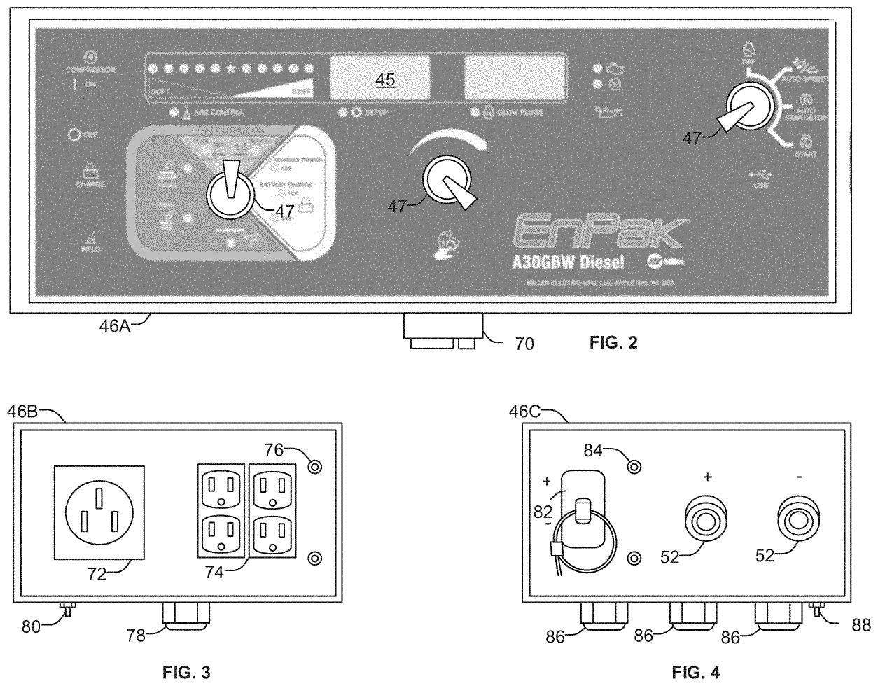

FIG. 2 illustrates an example remote control panel 46A. In the example of FIG. 2, the remote control panel 46A provides a user interface with one or more controls 47, including switches, touch screen capability, buttons, dials, knobs, or other suitable devices for operating the vehicle, service pack, components, etc. In the example of FIG. 3, the remote control panel 46A is configured to provide a user interface to control the power output panels 46B-46C, as well as other components associated with the vehicle or the power system, including the generator 34 as well as the hydraulic pump 36 and the air compressor 38. Further, the interface includes one or more displays 45, which may include a digital display, a visible and/or audible alert, dedicated icons for associated components, as well as other indicators to aid in the operator's control and understanding of the various systems by providing indications of a characteristic of one or more process (e.g., that power is being provided to a receptacle of the one or more power output panels and/or tools, level of power, etc.).

For example, the digital display 45 that may provide information corresponding to which components are operating and at what level, engine run time, power system fuel levels, maintenance information (e.g., maintenance alerts indicating that one or more components of the power system require repair or preventative maintenance). In some examples, a safety device, such as an electrical fuse, a circuit breaker, etc., may be provided on the remote control panel 46A.

As shown, each of the panels 46A-46C are constructed as enclosures to protect components inside. Example panels are constructed with sheet metal, composite materials, and/or rigid plastics. In some examples, the panels may be constructed of aluminum, which is lighter weight than stainless steel.

The remote control panel 46A may include a port 70 or other pathway to accept cabling, power, etc. Such a port 70 may include strain-relieving device to ensure that the cabling is protected during operation and/or installation. Within the remote control panel 46A, one or more of a relay, a processor, a circuit, a power source, a network interface, for instance, may be included to receive information from a control 47, and/or provide information for a display 45. Information may be further received and transmitted via the network interface, to control one or more of the various system components, the vehicle, and/or a remotely located device and/or processor.

Further, although described with respect to wired communication, the remote control panel 46A may be configured to send and receive information via one or more other communication techniques, which may expand functionality, limit the number of cables running to and from the panels, as well as reduce the size of the panels. This could include adding wireless communications (Bluetooth, cell, ZigBee, etc.).

FIG. 3 illustrates a power output panel 46B configured to provide power to a 240 volt AC output 72 and/or a 120 volt AC power output 74. One or more safety devices 76, 80 can be located on the panel 46B near the point of connection. Although illustrated as configured to provide AC power, one or more outputs for DC power may be provided on this or another panel of the modular remote panels 46A-C. As shown in FIG. 3, the wiring and/or cabling are connected to the panel 46B via one or more connectors 78 and/or strain relief devices.

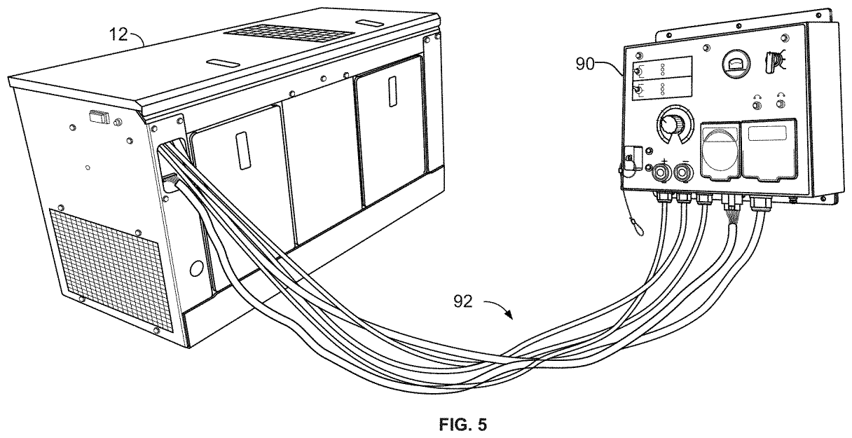

FIG. 4 illustrates power output panel 46C configured to provide power to a welding-type tool via output ports 52 and/or a battery charger via power output 82. One or more connectors 86 are included for cabling to provide power for the associated outputs. Moreover, safety devices 84, 88 are included with the panel at the point of connection.

Although remote control panel 46A is illustrated as providing controls 47 and display 45 without any power output, one or more power outputs may be included on remote control panel 46A, as needed. Further, although remote power output panels 46B-46C are shown with power outputs 72, 74, 52 and 82 without integrated controls and/or displays, one or more of such controls and/or displays may be provided at the point of connection, including with remote power output panels 46B-46C. Power output panel 46B may further include one or more cabling ports 86, which may include strain-relief devices as described above. Additionally or alternatively, one or more safety devices 84, 88 can be located on the panel 46C similar to those described with respect to FIG. 3.

Moreover, the remote panels 46A-46C shown in FIGS. 1-4 may include attachment points such that each panel may be installed on the work truck and/or other installation location. For example, each panel may be secured to the vehicle and/or other structure by employing one or more fasteners, which, in cooperation with a fastener and/or support structure at a second securing location (e.g., a hook, complimentary housing, magnetic attachment, screw, bolt, etc.).

Although described as modular, standalone panels, one or more of the panels 46A-46C may be configured to be mounted together and/or to have cabling routed through another. For example, one such panel (e.g., remote control panel 46A) may serve as a hub for the other panels (e.g., power output panels 46B-46C). In this example, wiring for communications and/or power may be routed to the hub, and the other panels may be configured to physically separate, such as by extending the cabling for each panel from the hub. Thus, a larger remote could be created that may be separable into other modular panels, and/or may include internal removable remotes, as space and/or functionality may require.

FIG. 5 illustrates an example cabling set up for a power system 12 and a conventional remote panel 90 for controlling the power system 12 and providing outputs thereon. As shown in FIG. 5, cables 92 include multiple separate cables (e.g., electrical cabling for control functions, to provide welding power, AC power, DC power, etc.) between the power system and the remote control panel 90. Thus, the cables 92 may include AC power cables, DC power cables, weld power cables, ground or reference cables, and/or control cables. In the example of FIG. 5, the cables 92 are connected to both of the conventional remote panel 90 and the power system 12 housing or case component for components of the remote panel 90, which functions as a case or enclosure for user interface circuitry, control circuitry, and/or any other types of circuitry.

While only certain features of the subject matter have been illustrated and described herein, many modifications and changes will occur to those skilled in the art.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

While the present method and/or system has been described with reference to certain implementations, it will be understood by those skilled in the art that various changes may be made and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

What is claimed is:

1. A plurality of modular panels for a vehicle mounted welding-type power system, comprising:
a control panel to transmit information to and receive information from a control device of the welding-type power system;
a first power output panel configured to provide power to a welding-type tool or a battery charger; and
a second power output panel configured to provide power output to an auxiliary device, wherein each of the control panel, the first power output panel and the second power output panel are in electrical communication with the welding-type power system, the control device configured to control power output to the first and second power output panels based on information from the control panel.

2. The plurality of modular panels as defined in claim 1, wherein each of the control panel, the first power output panel and the second power output panel are configured to be positioned at locations on the vehicle that are separate and remote from one another.

3. The plurality of modular panels as defined in claim 1, wherein the first power output panel is connected to the power system via a first power cable.

4. The plurality of modular panels as defined in claim 2, wherein the second power output panel is connected to the power system via a second power cable.

5. The plurality of modular panels as defined in claim 4, wherein the first power output cable comprises a plurality of conductors of a first conductor gauge that is greater than a second conductor gauge of a plurality of conductors of the second power output cable.

6. The plurality of modular panels as defined in claim 5, wherein the control panel is connected to the power system via one or more conductors with a third conductor gauge that is smaller than the conductor gauge of the second power output cable.

7. The plurality of modular panels as defined in claim 1, further comprising a mount to secure one or more of the control panel, the first power output panel or the second power output panel to the vehicle.

8. The plurality of modular panels as defined in claim 1, wherein the control panel is configured as a hub, such that the first cable and the second cable are channeled through the control panel to each of the first and second power output panels for placement remote from the control panel.

9. The plurality of modular panels as defined in claim 1, wherein one or more of the control panel, the first power output panel, and the second power output panel is housed in a frame comprising aluminum, sheet metal or rigid plastic.

10. A power system for a vehicle, comprising:
a generator to generate electrical power and to be installed on the vehicle;
a control device configured to receive information for controlling electrical power output of the generator;
a first power output panel located at a first location on the vehicle and configured to provide electrical power from the generator to a welding-type tool or a battery charger;
a second power output panel located at a second location on the vehicle and configured to provide electrical power from the generator to an auxiliary device; and
a control panel located at a third location on the vehicle and configured to receive information from and transmit information to the control device of the power system via a control cable.

11. The power system as defined in claim 10, wherein the electrical power output comprises at least one of a 120V alternating current output, a 240V alternating current output, a 24V direct current output, or a 12V direct current output.

12. The power system as defined in claim 11, wherein the control panel comprises a selection switch to control an output voltage of the electrical output.

13. The power system as defined in claim 11, wherein the first power output panel comprises a welding output connector to provide the electrical power output to the welding-type tool.

14. The power system as defined in claim 13, further comprising electrical conversion circuitry configured to receive the electrical power from the generator and to provide converted electrical power to the electrical output based on a selection.

15. The power system as defined in claim 11, wherein the second power output panel comprises an output receptacle to provide the electrical power output as 120V or 240V alternating current output.

16. The power system as defined in claim 10, wherein one of the first and second power output panel comprises an indicator to alert the operator to a characteristic of an output associated with the respective panel.

17. The power system as defined in claim 10, wherein the control panel is further configured to control one or more components associated with the vehicle or the power system, the one or more components including the generator, a hydraulic pump or an air compressor.

18. A vehicle mounted welding-type power system, comprising:
a generator to generate electrical power and to be installed on the vehicle;
a control device configured to receive information for controlling electrical power output of the generator;
a first power output panel located at a first location on the vehicle and configured to provide welding-type electrical power from the generator to a welding-type tool or a battery charger;
a second power output panel located at a second location on the vehicle and configured to provide electrical power from the generator to an auxiliary device; and
a control panel located at a third location on the vehicle and configured to:
receive an input from a user to provide electrical power to the first power output panel or the second power output panel; and
transmit the input to the control device of the power system to control the electrical power output.

19. The power system as defined in claim 18, wherein the control panel comprises:
a first control panel to control the first power output; and
a second control panel separate and remote from the first control panel, the second control panel configured to control the second power output

20. The power system as defined in claim 18, wherein the control panel is configured to transmit information to and receive information from the power system wirelessly to control the first and second power outputs.
